(19) United States
(12) Patent Application Publication
(10) Pub. No.: US 2009/0013029 A1
(43) Pub. Date: Jan. 8, 2009

(54) DEVICE, SYSTEM AND METHOD OF OPERATING A PLURALITY OF VIRTUAL LOGICAL SITES

(76) Inventors: Rhonda L. Childress, Austin, TX (US); Patrick B. Heywood, Louisville, CO (US); Dean Har'el Lorenz, Haifa (IL); Yosef Moatti, Haifa (IL); Ezra Silvera, Haifa (IL); Martin Jacob Tross, Haifa (IL)

Correspondence Address: Suzanne Erez;IBM CORPORATION, Intellectual Property Law Dept., P.O. Box 218, Yorktown Heights, NY, 10598, US

(21) Appl. No.: 11/772,845

(22) Filed: Jul. 3, 2007

(51) Int. Cl. G06F 15/16

(52) U.S. Cl. 709/203

(57) ABSTRACT

Some demonstrative embodiments of the invention include, for example, devices, systems and methods of operating one or more virtual logical sites. A method may include, for example, running on a server at least one first virtual machine implementing at least part of a first virtual logical site, and at least one second virtual machine implementing at least part of a second virtual logical site interchangeable with the first virtual logical site. Other embodiments are described and claimed.

### FIELD

Some demonstrative embodiments of the invention are related to the field of computing logical sites.

### BACKGROUND

A computing system often includes one or more host computing platforms (“hosts”) to process data and run application programs; direct access storage devices (DASDs) to store data; and a storage controller to control transfer of data between the hosts and the DASD.

One or more client computers (“clients”) may communicate with the computing system, e.g., to send data to, or receive data from, the computing system, through a direct communication link or a distributed data network, such as a network utilizing Transmission Control Protocol—Internet Protocol (“TCP/IP”). A client may submit a request for data stored on or generated by the computing system, and/or send to the computing system data to be processed by and/or stored on the computing system. One example of such a computing system is a bank's computer system, which system may provide a client with information relating to a particular bank account, and/or store information from a client regarding a transaction relating to an account. An interaction between the client and the computing system may be termed a transaction.

The computing system may typically be implemented as an interconnected computing system including one or multiple servers, possibly grouped into server clusters. A server or server-cluster in a multi-server computing system may play either a unique or redundant role relative to other servers in the system. The interconnected computing system may include a combination of two or more tiers, each including one or more servers/applications of the same type. For example, the interconnected computing system may include a WEB/HTML server tier, an application server tier, and a database server tier.

FIG. 1 shows an extended computing system including two physical sites. The computing system of FIG. 1 functions such that all the computing platforms, e.g. servers, in both physical sites operate as part of a unified production computing system, each of which continually supports some fraction of the system's overall production load, e.g., substantially at all times. For example, the service-cluster on the left side of FIG. 1 may represent an international bank's web/ecommerce site located in a first geographical location, e.g., NY, while the cluster on the right side may represent the same bank's web/ecommerce site in a second geographical location, e.g., London. The system of FIG. 1 may be implemented as a redundant mirrored computing system such that the content of both sites may be substantially identical. For example, each physical site may represent a complete and updated image of a main site represented by the extended computing system as whole. Substantive content on both physical sites may be maintained in substantial synchronization using various synchronization technologies.

In some implementations the system of FIG. 1 is managed using suitable load balancing technologies to efficiently allocate production workload (“traffic”) between the first and second physical sites, e.g., according to resource availability.

In some implementations a portion of the extended computing system shown in FIG. 1, for example, the physical site in London, is a secondary backup/mirror computing system maintained as a content mirror or backup system for the primary physical site in New York, so that in the event the primary site reaches its maximum operating capacity/load, or in the event the primary site fails, data service requirements are still addressed.

Another application of redundant mirrored computing systems, aside from failover security and load balancing, is staging/anticipating a change/updating of a site. The “change-over” may include any updating or modification of any system component, either during runtime, during a downtime period, or at intervals between code executions. Since a change or update to a complex computing system may have unanticipated and undesirable results (e.g. system crash), it has become common practice to first apply the updates within a testing environment including, for example, a mirrored copy of the production environment. Should the testing of the change-over/update be successful and the updated system perform stably within expected performance parameters, the same change-over or update may then be performed on the production system.

Although the substantive content on both clusters/sites is maintained in substantial synchronization using various synchronization technologies, the hardware platforms, interconnection hardware, e.g., routers, switches, bridges and the like, and/or server software used at each of the sites may differ greatly. Furthermore, since each of the sites may have been assembled at different times with different hardware and/or software components, e.g., applications, database applications, and the like, despite representing logically related/identical sites whose content is substantially synchronized, the two sites may behave quite differently under different conditions and may require different procedures for upgrading of operating system software.

Presently known methodology and technology for establishing and maintaining a multi-server and/or multi-site system have drawbacks in several aspects, including:
Management overhead—additional work is required to maintain and support additional servers and sites at different locations.

Hardware overhead—multi-site settings require enough hardware to support the production traffic if one site is down. For example, capacities of 200% or 150% are required for systems including two or three sites.

Synchronizing applications—assuring that the functionality and/or services are substantially identical two or more sites, and/or assuring that the applications function properly and with the same outcome on two or more sites.

Data synchronization—assuring that the data is consistent between sites. A data update which occurs on a first server that affect the outcome of a second server should be applied to the second server as well. For example, if a withdrawal of 100$ was made at the New York site a second withdrawal of 100$ was made at the London site, the account balance should be updated on both sites to represent a decrement of 200$.

Policies synchronization—make sure that the same policies apply on two or more sites. For example, if a user account was disabled on one site then that user account should be disabled on other sites as well.

### SUMMARY

Some demonstrative embodiments of the invention include, for example, devices, systems and methods of operating one or more virtual logical sites.

According to some demonstrative embodiments, a computing system includes one or more servers to run at least first and second interchangeable virtual logical sites, wherein a server of the one or more servers is to run at least one first virtual machine implementing at least part of the first virtual logical site and at least one second virtual machine implementing at least part of the second virtual logical site.

According to some demonstrative embodiments, the first and second virtual machines are interchangeable.

According to some demonstrative embodiments, the first virtual machine is a substantial clone of the second virtual machine.

According to some demonstrative embodiments, the first virtual machine implements a service of a type different than a service type implemented by the second virtual machine.

According to some demonstrative embodiments, the first and second virtual logical sites are substantial clones.

According to some demonstrative embodiments, the computing system may include at least one virtualization manager to allocate one or more physical resources of the server between the first and second virtual machines based on a traffic load of traffic intended for the first and second virtual logical sites.

According to some demonstrative embodiments, the computing system may include at least one synchronization manager to synchronize between corresponding virtual machines of the first and second virtual logical sites.

According to some demonstrative embodiments, when a change-over operation is to be performed the one or more servers are to route production traffic to the second virtual logical site; modify the first virtual logical site to generate a modified first virtual logical site; and route the production traffic to the modified first virtual logical site and to the second virtual logical site.

According to some demonstrative embodiments, the one or more servers are to operate the modified first virtual logical site in a testing environment.

According to some demonstrative embodiments, the server is to allocate one or more physical resources of the server between the first and second virtual machines during the change over operation.

According to some demonstrative embodiments, the one or more servers are to route the production traffic to the modified first virtual logical site; modify the second virtual logical site to generate a modified second virtual logical site; and route the production traffic to the modified first and second virtual logical sites.

According to some demonstrative embodiments, the at least one first virtual machine includes a plurality of first virtual machines implementing a first plurality of services of the first virtual logical site. The at least one second virtual machine includes a plurality of second virtual machines implementing a second plurality of services of the second virtual logical site.

According to some demonstrative embodiments, the computing system may include a dispatcher to dispatch traffic to the first and second virtual logical sites via a single entry point.

According to some demonstrative embodiments, a method may include running on a server at least one first virtual machine implementing at least part of a first virtual logical site, and at least one second virtual machine implementing at least part of a second virtual logical site interchangeable with the first virtual logical site.

According to some demonstrative embodiments, the first and second virtual machines are interchangeable.

According to some demonstrative embodiments, the first virtual machine is a substantial clone of the second virtual machine.

According to some demonstrative embodiments, the first and second virtual logical sites are substantial clones.

According to some demonstrative embodiments, the method may include running the first and second virtual logical sites on a set of one or more servers including the server.

According to some demonstrative embodiments, the method may include allocating one or more physical resources of the server between the first and second virtual machines based on a traffic load of traffic intended for the first and second virtual logical sites.

According to some demonstrative embodiments, the method may include synchronizing between the first and second virtual logical sites.

According to some demonstrative embodiments, the method may include performing a change over operation including routing production traffic to the second virtual logical site. The method may also include modifying the first virtual logical site to generate a modified first virtual logical site, and routing the production traffic to the modified first virtual logical site and the second virtual logical site. The method may also include allocating one or more physical resources of the server between the first and second virtual machines during the change over operation.

According to some demonstrative embodiments, the method may include routing the production traffic to the modified first virtual logical site; modifying the second virtual logical site to generate a modified second virtual logical site; and routing the production traffic back to the modified first and second virtual logical sites.

According to some demonstrative embodiments, the method may include operating the modified first virtual logical site in a testing environment.

According to some demonstrative embodiments, running the at least one first virtual machine includes running on the server a plurality of first virtual machines implementing a first plurality of services of the first virtual logical site. Running the at least one second virtual machine may include running on the server a plurality of second virtual machines implementing a second plurality of services of the second virtual logical site.

Some demonstrative embodiments include server to run at least one first virtual machine implementing at least part of a first virtual logical site and at least one second virtual machine implementing at least part of a second virtual logical site interchangeable with the first virtual logical site.

According to some demonstrative embodiments, the first and second virtual machines are interchangeable.

According to some demonstrative embodiments, the first virtual machine is a substantial clone of the second virtual machine.

According to some demonstrative embodiments, the first and second virtual machines implement at least one different service.

According to some demonstrative embodiments, when a change over operation is to be performed the server is to modify the first virtual machine.

According to some demonstrative embodiments, the server is to allocate one or more physical resources of the server between the first and second virtual machines during the change over operation.

According to some demonstrative embodiments, the at least one first virtual machine includes a plurality of first virtual machines implementing a first plurality of services of the first virtual logical site, and the at least one second virtual machine includes a plurality of second virtual machines implementing a second plurality of services of the second virtual logical site.

Some demonstrative embodiments include a computer program product comprising a computer-useable medium including a computer-readable program, wherein the computer-readable program when executed on at least one computer causes the computer to run at least one first virtual machine implementing at least part of a first virtual logical site, and at least one second virtual machine implementing at least part of a second virtual logical site interchangeable with the first virtual logical site.

According to some demonstrative embodiments, the computer-readable program causes the at least one computer to allocate one or more physical resources of the computer between the first and second virtual machines based on a traffic load of traffic intended for the first and second virtual logical sites.

According to some demonstrative embodiments, the computer-readable program causes the at least one computer to perform a change-over operation including routing production traffic to the second virtual logical site; modifying the first virtual logical site to generate a modified first virtual logical site; and routing the production traffic the modified first virtual logical site and the second virtual logical site.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 schematically illustrates a typical computing system including two physical sites;

FIG. 2 schematically illustrates a computing system having a plurality of Virtual Logical Sites (VLS) in accordance with some demonstrative embodiments of the invention;

FIG. 3 conceptually illustrates a VLS topology in accordance with one demonstrative embodiment of the invention;

FIG. 4 conceptually illustrates a VLS topology in accordance with another demonstrative embodiment of the invention;

FIG. 5 conceptually illustrates a VLS topology in accordance with yet another demonstrative embodiment of the invention; and

FIG. 6 schematically illustrates a flow chart of a method of operating a plurality of VLSs, in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of items” may include two or more items.

Some demonstrative embodiments of the invention may be implemented using a computing platform or a host. Although the invention is not limited in this respect the computing platform or host include, for example, a processor, an input unit, an output unit, a memory unit, a storage unit, a communication unit, and/or any other suitable hardware and/or software components. The processor includes, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller. The processor may, for example, execute instructions, execute one or more software applications, and process signals and/or data transmitted and/or received by the computing platform. The input unit includes, for example, a keyboard, a keypad, a mouse, a touch-pad, a stylus, a microphone, or other suitable pointing device or input device. The output unit includes, for example, a cathode ray tube (CRT) monitor or display unit, a liquid crystal display (LCD) monitor or display unit, a screen, a monitor, a speaker, or other suitable display unit or output device. The memory unit includes, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. The storage unit includes, for example, a hard disk drive, a floppy disk drive, a compact disk (CD) drive, a CD-ROM drive, a digital versatile disk (DVD) drive, or other suitable removable or non-removable storage units. The memory unit and/or storage unit store, for example, data processed by the computing platform. The communication unit includes, for example, a wired or wireless network interface card (NIC), a wired or wireless modem, a wired or wireless receiver and/or transmitter, a wired or wireless transmitter-receiver and/or transceiver, a radio frequency (RF) communication unit or transceiver, or other units able to transmit and/or receive signals, blocks, frames, transmission streams, packets, messages and/or data.

Although embodiments of the invention are not limited in this regard, the term “Virtual Machine” (VM) as used herein may include one or more environments able to emulate, simulate, virtualize, execute, directly execute, run, implement, or invoke a hardware component, a software component, an Operating System (OS), an application, a code, a set of instructions, or the like. The VM may be implemented using hardware components and/or software components. In one example, the VM is implemented as a software application executed by a processor, or as a hardware component integrated within a processor.

Although embodiments of the invention are not limited in this regard, the term “server” as used herein may include any suitable process, program, method, algorithm, and/or sequence of operations, which may be executed by any suitable computing device, system and/or platform, e.g., a host, to provide, relay, communicate, deliver, send, transfer, broadcast and/or transmit any suitable information, e.g., to a client. The server may include any suitable server, e.g., an application server, a web server, a database server, and the like. A “physical server” may include a server implemented using any suitable server hardware and/or server software. A “virtual server” may include a server implemented by a VM. A physical server may run or execute one or more VMs.

Although embodiments of the invention are not limited in this regard, the term “logical site” as used herein may include a computing environment, architecture or topology including a combination of two or more different logical layers, tiers or vertical service applications adapted to provide a service, e.g., a data service, or a set of related services. The logical site may include, for example, one or more of a Hyper-Text-Transfer-Protocol (HTTP) server, a web server, a HyperText-Markup-Language (HTML) server, a database (DB) server, a Lightweight-Directory-Access-Protocol (LDAP) service, a Distributed-File-System (DFS) service, a Domain-Name-Server (DNS) service, a backup service, and the like. The logical tiers and/or vertical services may be implemented by a single computing platform/server; multiple interconnected computing platforms/servers, e.g., a server cluster; multiple interconnected server clusters (“a physical site”); or multiple interconnected physical sites. The logical site may be implemented by a combination of one or more physical servers and/or one or more logical servers. In one example, the logical site may be self-contained, e.g., the logical site may implement one or more internal services, e.g., services internally used by the logical site. In another example, the logical site may not be self-contained, for example, the logical site may use and/or rely on one or more external services, which may serve as components of another service, e.g., external to the logical site. The logical site may be adapted to process service requests. The traffic of the service requests to the logical site may be controlled using any suitable traffic controller, e.g., a gateway, dispatcher, load-balancer, and the like.

Although embodiments of the invention are not limited in this regard, the term “virtual logical site” (VLS) as used herein may include a logical site or a subsection of a logical site including a plurality of logical tiers and/or services being virtually implemented, e.g., using a plurality of VMs. For example, the VLS may include one or more of a virtual HTTP server implemented by at least one HTTP server VM; a virtual web server implemented by at least one web server VM; a virtual HTML server implemented by at least one HTML server VM; a virtual DB server implemented by at leas one DB server VM; a virtual LDAP service implemented by at least one LDAP VM; a virtual DFS service implemented by at least one DFS VM, a virtual DNS service implemented by at least one DNS VM; a backup service implemented by at least one backup VM, and/or any other suitable virtual tier and/or service. The VLS may be implemented by any suitable VLS architecture and/or topology using one or more physical servers, e.g., as described herein. In one example, the VLS may be implemented using a plurality of physical servers, wherein each of the physical servers runs a VM implementing at least one service of the VLS. In another example, the VLS may be implemented using a single physical server to run to VMs of all services of the VLS. Traffic of service requests to the VLS may be controlled using any suitable traffic controller, e.g., a gateway, dispatcher, load-balancer, and the like.

At an overview, some demonstrative embodiments of the invention may include a device, system and/or method of operating two or more VLSs commonly using one or more physical servers in a manner, which for example, allows dynamic reallocation of physical resources between the VLSs. In one example, one or more physical servers run VMs of first and second VLSs. For example, a first physical server may run both a VM implementing a web server of the first VLS, and a VM implementing the web server of the second VLS; a second physical server may run both a VM implementing an application server of the first VLS, and a VM implementing the application server of the second VLS; a third physical server may run both a VM implementing a DB server of the first VLS, and a VM implementing the DB server of the second VLS; and/or one or more other physical servers commonly running VMs of tiers and/or services of both VLSs. In another example, a single physical server may run a plurality of VMs of both the first and second VLSs, e.g., the physical server runs VMs of two or more of the web server, the application server and/or the DB server belonging to the first and second VLSs. Optionally, VMs of the VLSs may share a common infrastructure, for example, a network, and/or an external storage, using any suitable virtualization technology, e.g., the VMs may share a Local Area Network (LAN) using a Virtual LAN (VLAN).

In some demonstrative embodiments, the first and second VLSs are substantially interchangeable with one another. Although the invention is not limited in this respect, two or more computing modules, e.g., VLS or VMs, are considered interchangeable if, for example, each of the computing modules may take over the function of others of the two or more computing modules, and the two or more computing modules provide substantially the same functionality. In one example, a physical server runs first and second interchangeable VMs, wherein the first VM implements a certain tier or service of the first VLS, and the second VM implements the certain tier or service of the second VLS. In another example, the first and second VMs may implement logical tiers or services of different types, e.g., as described below.

In some demonstrative embodiments of the invention, the plurality of VLSs may enable performing maintenance operations, e.g., a changeover, on the VLSs. Although embodiments of the invention are not limited in this respect the term “change-over” as used herein may include any suitable updating and/or modification of one or more components of a VLS, either during runtime, downtime or at intervals between code executions.

According to some demonstrative embodiments of the invention, a change-over to a first VLS may be performed by switching VMs of the first VLS from a production mode of operation to a disconnected mode of operation, in which the VMs are disconnected from production related traffic or workload. The production related traffic is routed, for example, to one or more other VLSs. The changeover may be performed on the disconnected VMs, and the disconnected VMs may be tested, e.g., while VMs of the other VLSs continue to remain in a production mode of operation. While the first VLS is in a disconnected mode of operation, computing platform resources allocation to the VMs of the first VLS may be decreased, while allocation of computing platform resources provided to VMs of the other VLSs may be increased. For example, computing resources of a server running first and second VMs of the first and second VLSs, respectively, may be reallocated between the first and second VMs such that the computing resources allocated to the VM of the disconnected VLS are decreased while the computing resources allocated to the other VM are increased.

According to some demonstrative embodiments of the invention, after undergoing a changeover the first VLS may be tested. As part of testing, the VMs which underwent a changeover may serve as a testing environment for the changeover. Accordingly, the disconnected and changed-over VMs may be operated in a testing mode, such that they use test data and/or synthetic test traffic, and access only test section of a database. If the changed-over VMs remain stable and operate within expected performance parameters, the changed-over VLS may be considered to have passed testing.

According to some demonstrative embodiments of the invention, once the first VLS has passed testing, it may be reconnected to production related traffic, and allocation of computing platform resources to VMs of the first VLS may be increased.

According to some demonstrative embodiments of the invention, once the first VLS has undergone the change-over and successful testing, a second VLS, e.g., of the other VLSs, may be disconnected from production traffic and substantially the same change-over which was performed on the first VLS may be performed on the second VLS. This may be generalized to any number of VLS providing a given set of data services.

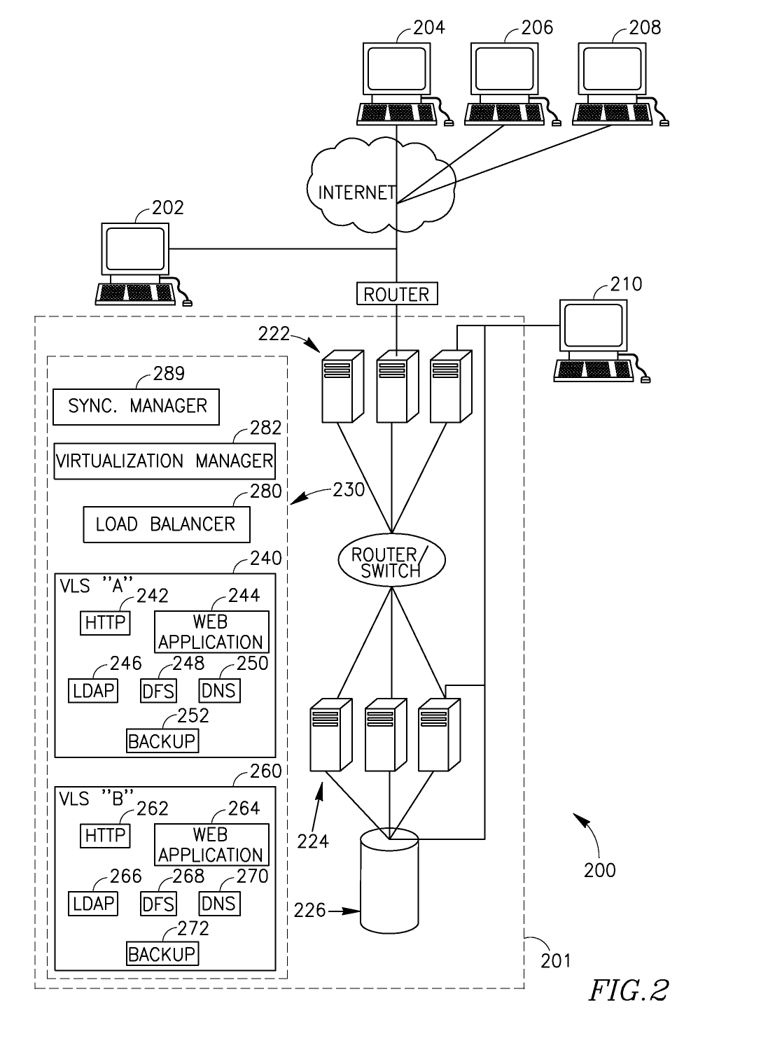

FIG. 2 schematically illustrates a computing system 200 in accordance with some demonstrative embodiments of the invention.

According to some demonstrative embodiments of the invention, system 200 provides a service to a plurality of client computers, e.g., client computers 202, 204, 206, 208, and/or 210, through a distributed network such as the Internet. System 200 may include one or multiple servers, possibly grouped into server clusters. A server or server-cluster in a multi-server computing system may play, for example, a unique or redundant role relative to other servers in the system. System 200 includes a logical site 201 including a combination of two or more logical tiers (also referred to as “layers”), each including one or more servers/applications of the same tier type. In one example, system 200 includes three tiers, e.g., a first tier 222 including one or more WEB/HTML servers, a second tier 224 including one or more application servers, and a third tier 226 including one or more database servers.

According to some demonstrative embodiments of the invention, system 200 includes a logical multi site having a VLS topology 230, which includes a plurality of VLSs implemented by one or more physical servers, e.g., one or more physical servers of tiers 222, 224, and/or 226, as described in detail below.

According to some demonstrative embodiments of the invention, VLS topology 230 includes a VLS 240, denoted “A”, including a plurality of services, e.g., a HTTP service 242, a web application service 244, a LDAP service 246, a DFS service 248, a DNS service 250, and/or a backup service 252. VLS topology 230 also includes a VLS 260, denoted “B”, including a plurality of services, e.g., a HTTP service 262, a web application service 264, a LDAP service 266, a DFS service 268, a DNS service 270, and/or a backup service 272.

According to some demonstrative embodiments of the invention, VLSs 240 and 260 share one or more servers, services, tiers or hardware components of system 200, e.g., as described below.

According to some demonstrative embodiments of the invention, VLSs 240 and 260 are implemented by one or more physical servers running a plurality of VMs. For example, services 242, 244, 246, 248, 250, 252, 262, 264, 266, 268, 270 and/or 272 are implemented by a plurality of VMs, e.g., twelve VMs.

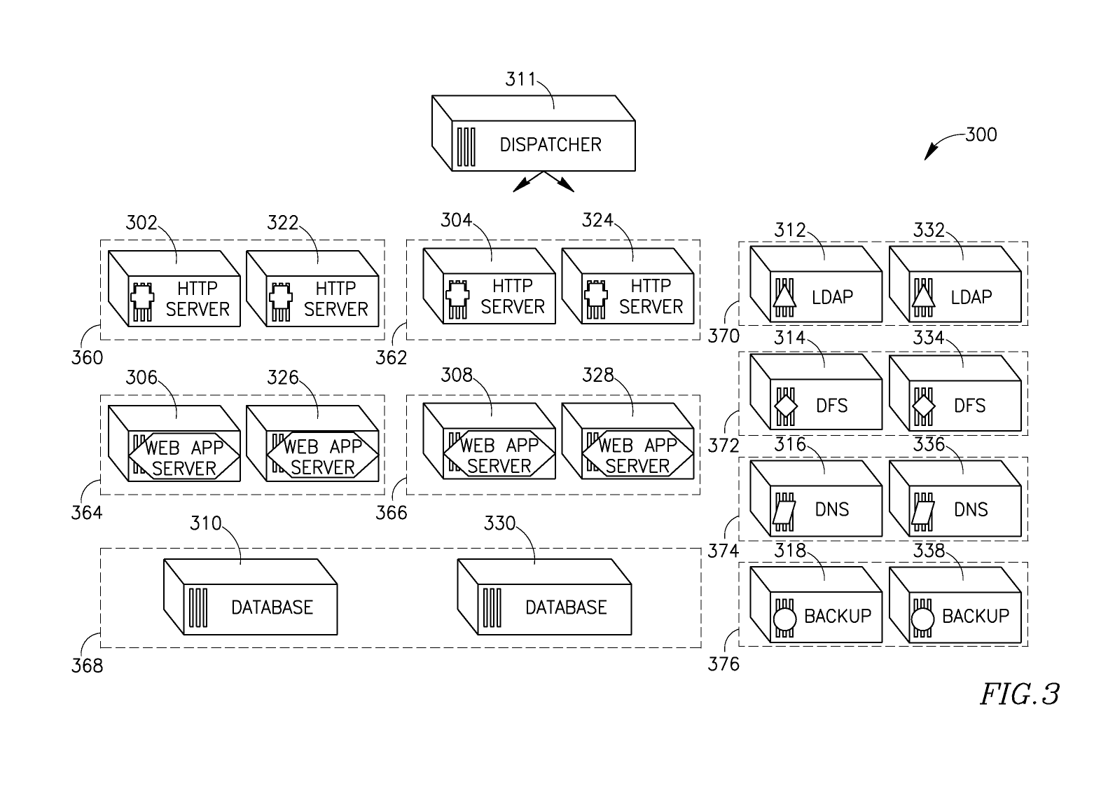

In some demonstrative embodiments of the invention, at least one physical server of system 200 commonly runs at least a first VM implementing a service of VLS 240 and a second VM implementing a service of VLS 260, e.g., as described in detail below with reference to FIGS. 3 4 and/or 5. In one example, a physical server of servers 222 runs a VM of HTTP service 242, and a VM of HTTP service 262; a physical server of servers 224 runs a VM of web application service 244, and a VM of web application service 264; and/or one or more physical servers of database servers 226 run a VM of LDAP service 246, a VM of LDAP service 266, a VM of DFS service 248, a VM of DFS service 268, a VM of DNS service 250, a VM of DNS service 270, a VM of backup service 252, and/or a VM of backup service 272, e.g., as described below.

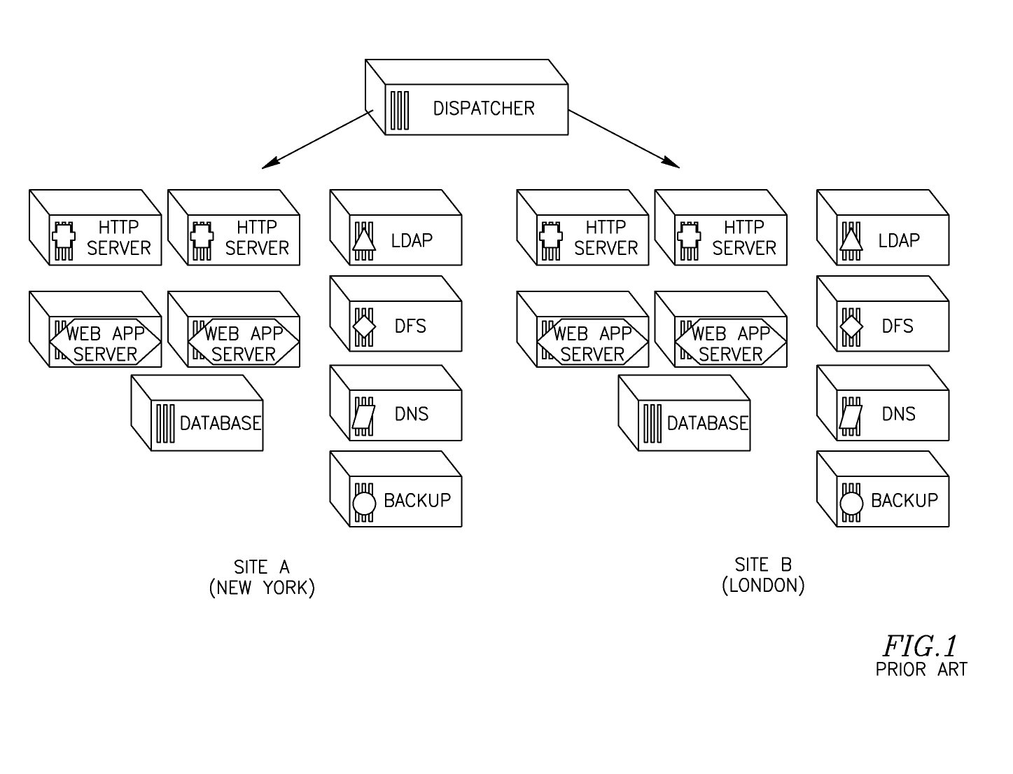

In some demonstrative embodiments of the invention, VLS 240 may be interchangeable with VLS 260. For example, VLSs 240 and 260 may concurrently provide substantially the same data services and/or other functionalities. Although the invention is not limited in this respect, in one example VLS topology 230 corresponds to a redundant mirrored computing system such that the functionality and/or content of both VLSs 240 and 260 may be substantially identical, e.g., in analogy to the redundant mirrored computing system described above with reference to FIG. 1.

In some demonstrative embodiments of the invention, one or more of the VMs of services 242, 244, 246, 248, 250, and/or 252 are interchangeable with one or more of the VMs of services 262, 264, 266, 268, 270 and/or 272, respectively. In one example, the VMs of services 242, 244, 246, 248, 250, and/or 252 are substantially identical to the VMs of services 262, 264, 266, 268, 270 and/or 272, respectively. In one example, one or more of the VMs of services 242, 244, 246, 248, 250, and 252 are clones of the VMs of services 262, 264, 266, 268, 270 and/or 272, respectively. Although the invention is not limited in this respect, the term “clone VMs’ as used herein may relate to two or more VMs having substantially identical disk images. The clone VMs may differ, for example, in identity information, tmp files, and the like.

In some demonstrative embodiments of the invention, VLS 240 and VLS 260 may be substantial clones. Although the invention is not limited in this respect, two or more VLSs may be considered clones, if the two or more VLSs have substantially the same VLS topology, wherein VMs of each of the VLSs are clones of VMs of other VLSs.

In some demonstrative embodiments of the invention, topology 230 may also include at least one load balancer 280 to route traffic to VLSs 240 and 260, e.g., as described in detail below.

According to some demonstrative embodiments of the invention, load balancer 280 dispatches traffic unevenly to VLSs 240 and 260, e.g., in accordance with any suitable load and/or hardware considerations.

According to one demonstrative embodiment of the invention, load balancer 280 dispatches traffic between VLSs 240 and 260 via a single entry point. According to another embodiment of the invention, load balancer 280 may logically implement a single entry-point dispatcher, which is not split between VLSs 240 and 260. According to yet another embodiment of the invention, traffic may be allowed to cross between VLSs 240 and 260. For example, load balancer 280 may dispatch traffic intended for VLS 240 to VLS 260, e.g., based on any suitable load-balancing policy.

According to some demonstrative embodiments of the invention, dispatching traffic to VLSs 240 and 260 may be achieved by using virtualization, thus, enabling the dispatching without using additional hardware. The virtualization is performed, for example, by creating a VM with SW dispatcher; using virtual networking for dispatching, e.g., VLAN or Virtual Input/Output (VIO); and embedding a dispatcher in a suitable hyper-visor (also known as a “VM monitor”), e.g., the VMware hyper-visor or the Power hyper-visor (PHype).

In some demonstrative embodiments of the invention, topology 230 may also include a virtualization manager 282 to allocate computing platform resources (“physical resources”) to VMs of VLSs 240 and 260, disconnect one or more of the VMs from production traffic, connect one or more of the VMs to a testing environment, and/or reconnect a VM to production, e.g., as described in detail below. For example, virtualization manager 282 may control allocation of the physical resources to at least one pair of VMs including a VM of VLS 240, e.g., the VM of service 242, and a VM of VLS 260, e.g., the VM of service 262.

According to some demonstrative embodiments of the invention, virtualization manager 282 may allocate between VLSs 240 and 260 physical resources, which may be shared between VLSs 240 and 260 (“shared resources”). For example, a VLS which is disconnected from production, e.g., during a change over as discussed below, may require a reduced level of physical resources. Accordingly, if one of VLSS 240 and 260 is disconnected from production, virtualization manager 282 may reduce the resources allocated to the disconnected VLS, and increase the resources allocated to the other VLS.

According to some demonstrative embodiments of the invention, VMs of VLS 240 may share one or more parts or components of their physical image, e.g., mount, read only, the same drive, with corresponding VMs of VLS 260, for example, if one or more of the VMs of services 242, 244, 246, 248, 250, and 252 are clones of one or more of the VMs of services 262, 264, 266, 268, 270 and/or 272, respectively.

According to some demonstrative embodiments of the invention, topology 230 may also include a synchronization manager 289 to synchronize VLS 240 with VLS 260. In one example, synchronization manager 289 may synchronize one or more VMs of VLS 240 with one or more corresponding VMs of VLS 260, respectively. For example, synchronization manager 289 may implement any suitable synchronization method, algorithm and/or technology, to perform software, data and/or policy synchronization between VMs of VLS 240 and 260. Although the invention is not limited in this respect, synchronizing two or more computing modules, e.g., VLSs and/or VMs, may include monitoring to discover differences between the modules, evaluating rules for ignoring expected differences between the modules, automatically creating the rules, e.g., after an update, reporting of disallowed differences, fixing broken images from a clone, and the like.

According to some further embodiment of the present invention, load balancer 280 may automatically load-balance between different VMs and/or VLSs, which are run by a common physical server. This may result in dispatching, while load balancing between the VLSs at the entry point, to be less dependent on load and more tolerant of errors.

It should be understood by one of ordinary skill in the art that although FIG. 2 shows a specific topology of a multi-server computing system, various configurations or topologies may be used to form a computing system and/or logical site. Although FIG. 2 shows embodiments of the invention in which each server tier, e.g., tiers 222, 224, and 226, is implemented using a separate physical server hardware, it will be appreciated that in other embodiments a single computing platform, e.g., a single processor or multiprocessor computer, may support one or more tiers. For example, a single computing platform may run in parallel two or more of a web server application, an application server application, and a database application. In some embodiments a single computing platform may run multiple sets of servers.

Reference is made to FIG. 3, which conceptually illustrates a VLS topology 300 including two VLSs, denoted “VLS I” and “VLS II”, respectively, in accordance with some demonstrative embodiments of the invention. Although the invention is not limited in this respect, VLS topology 300 may perform the functionality of VLS topology 230 (FIG. 2). For example, VLS I and VLS II may perform the functionality of VLSs 240 and 260 (FIG. 2), respectively.

According to some demonstrative embodiments of the invention, VLS I includes a HTTP service implemented by a first HTTP VM 302 running on a physical server 360, and a second HTTP VM 304 running on a physical server 362; a web application service implemented by a first web application VM 306 running on a physical server 364, and a second web application VM 308 running on a physical server 366; a LDAP service implemented by a LDAP VM 312 running on a physical server 370; a DFS service implemented by a DFS VM 314 running on a physical server 372; a DNS service implemented by a DNS VM 316 running on a physical server 374; a backup service implemented by a backup VM 318 running on a physical server 376; and a database service implemented by a database VM 310 running on a physical server 368. VLS II includes a HTTP service implemented by a first HTTP VM 322 running on physical server 360, and a second HTTP VM 324 running on physical server 362; a web application service implemented by a first web application VM 326 running on physical server 364, and a second web application VM 328 running on physical server 366; a LDAP service implemented by a LDAP VM 332 running on physical server 370; a DFS service implemented by a DFS VM 334 running on physical server 372; a DNS service implemented by a DNS VM 336 running on physical server 374; a backup service implemented by a backup VM 338 running on physical server 376; and a database service implemented by a database VM 330 running on physical server 368.

According to the demonstrative embodiments of FIG. 3, each of servers 360, 362, 364, 366, 368, 370, 372, 374, and/or 376 commonly runs both a first VM of a service of VLS I and a corresponding VM of a tier of VLS II. As shown in FIG. 3, each of servers 360, 362, 364, 366, 368, 370, 372, 374, and/or 376 runs VMs of the same service type, e.g., servers 360 and 362 each run VMs of the HTTP service, servers 364 and 366 each run VMs of the web application service, and servers 368, 370, 372, 374 and 376 run VMs of the database, LDAP, DFS, DNS, and backup services, respectively.

According to some demonstrative embodiments of the invention, VLS I and VLS II may be interchangeable or substantial clones. For example, VM 302 may be a substantial clone of VM 322, VM 304 may be interchangeable to, or a substantial clone of, VM 324; VM 306 may be interchangeable to, or a substantial clone of, VM 326, VM 308 may be interchangeable to, or a substantial clone of, VM 328; VM 310 may be interchangeable to, or a substantial clone, of VM 330; VM 312 may be interchangeable to, or a substantial clone of; VM 332; VM 314 may be interchangeable to, or a substantial clone of, VM 334; VM 316 may be interchangeable to, or a substantial clone of, VM 336; and/or VM 318 may be interchangeable to, or a substantial clone of, VM 338. Accordingly, even a single one of VLS I and VLS II may perform the functionality of a complete logical site, for example, when another one of VLS I and VLS II is not operating in a production mode, e.g., when the other VLS is undergoing a change-over.

According to some demonstrative embodiments of the invention, topology 300 may also include a dispatcher 311 to route traffic, e.g., production traffic and/or test traffic, to VMs of VLS I and VLS II, e.g., as described above with reference to load balancer 280 (FIG. 2). For example, dispatcher 311 may route traffic to VMs of both VLS I and VLS II, e.g., when both VLS I and VLS II are at the production mode of operation. Dispatcher 311 may route, for example, all production traffic only to VMs of VLS II, e.g., when VLS I is at a disconnected mode of operation. For example, when VLS I is at the disconnected mode of operation, e.g., during a change over of VLS I, dispatcher 311 may route all production traffic to VMs 322, 324, 326, 328, 330, 332, 334, 336, and/or 338, for example, while not routing any production traffic to VMs 302, 304, 306, 308, 310, 312, 314, 316 and/or 318. In this example, the amount of physical resources allocated, e.g., by manager 282 (FIG. 2), to VMs 322, 324, 326, 328, 330, 332, 334, 336, and/or 338 may be increased while the amount of physical resources allocated to VMs 302, 304, 306, 308, 310, 312, 314, 316 and/or 318 may be decreased.

According to some demonstrative embodiments of the invention, dispatcher 311 may dispatch traffic between VLSs I and II via a single entry point. In one example, dispatcher 311 may allow traffic to cross between VLS I and VLS II. In another example, dispatcher 311 may dispatch traffic unevenly to VLS I and VLS II, e.g., in accordance to load and/or hardware considerations. In some demonstrative embodiments, dispatcher 311 may be implemented using virtualization, as described above.

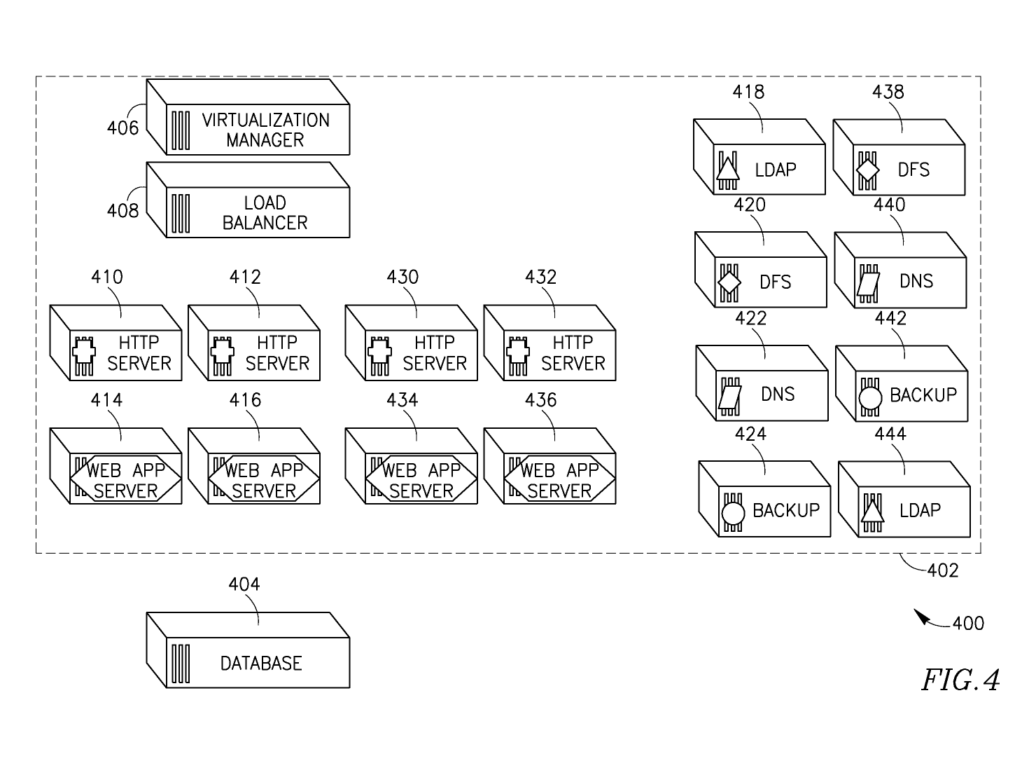

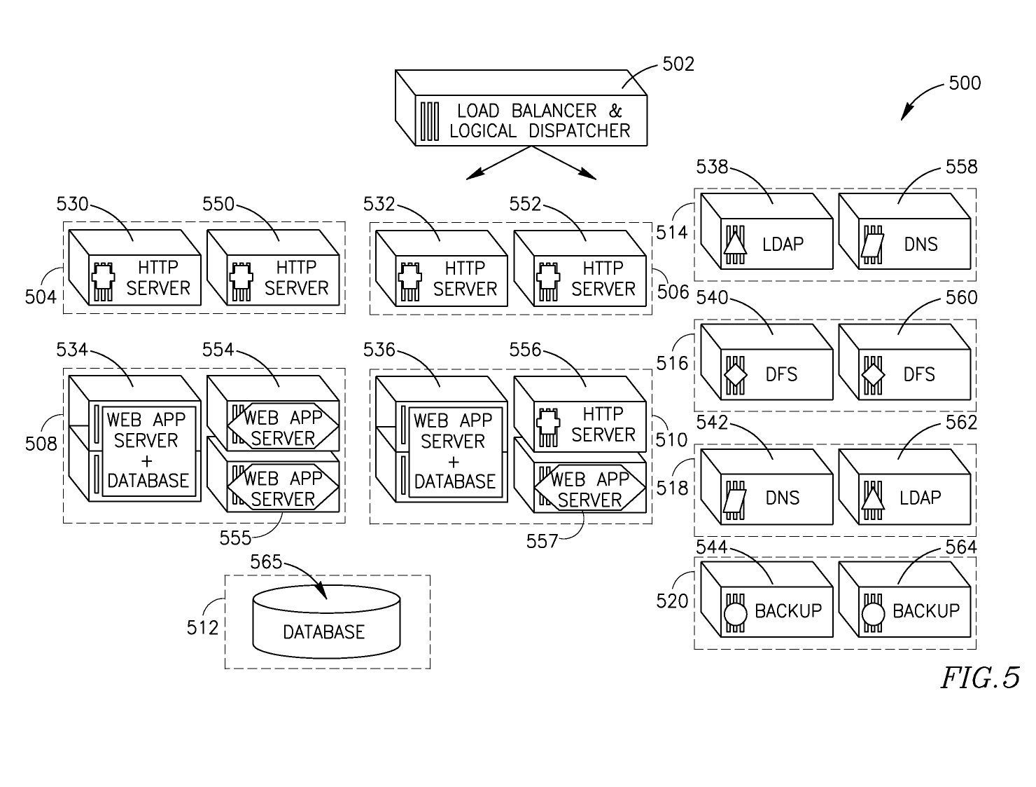

The embodiments of FIG. 3 include a VLS topology, wherein each physical server runs a pair of VMs of a single service of each of the VLSs. However, embodiments of the invention are not limited in this respect. For example, in some embodiments a physical server may run VMs of two or more services, e.g., as described below with reference to FIG. 4; a physical server may run a VM of a first service of a first VLS and a VM of a second service of a second VLS, wherein the first and second services are of different types, e.g., as described below with reference to FIG. 5; and/or any other suitable configuration of physical servers and/or VMs.

Reference is made to FIG. 4, which conceptually illustrates a VLS topology 400 including two VLSs, denoted “VLS 1” and “VLS 2”, respectively, in accordance with some demonstrative embodiments of the invention. Although the invention is not limited in this respect, VLS topology 400 may perform the functionality of VLS topology 230 (FIG. 2). For example, VLS 1 and VLS 2 may perform the functionality of VLSs 240 and 260 (FIG. 2), respectively.

According to some demonstrative embodiments of the invention, VLS 1 and VLS 2 may be implemented using a singles physical server 402. For example, VLS 1 includes a HTTP service implemented by a first HTTP VM 410 running on physical server 402, and a second HTTP VM 412 running on physical server 402; a web application service implemented by a first web application VM 414 running on physical server 402, and a second web application VM 416 running on physical server 402; a LDAP service implemented by a LDAP VM 418 running on physical server 402; a DFS service implemented by a DFS VM 420 running on physical server 402; a DNS service implemented by a DNS VM 422 running on physical server 402; and a backup service implemented by a backup VM 424 running on physical server 402. VLS II includes a HTTP service implemented by a first HTTP VM 430 running on physical server 402, and a second HTTP VM 412 running on physical server 432; a web application service implemented by a first web application VM 434 running on physical server 402, and a second web application VM 436 running on physical server 402; a DFS service implemented by a DFS VM 438 running on physical server 402; a DNS service implemented by a DNS VM 440 running on physical server 402; a backup service implemented by a backup VM 442 running on physical server 402; and a LDAP service implemented by a LDAP VM 444 running on physical server 402.

According to the demonstrative embodiments of FIG. 4, both VLS 1 and VLS 2 share a common database server 404.

According to some demonstrative embodiments of the invention, VLS 1 and VLS 2 may be interchangeable. In one example, VM 410 may be interchangeable to, or a substantial clone of, VM 430; VM 412 may be interchangeable to, or a substantial clone of VM 432; VM 414 may be interchangeable to, or a substantial clone of, VM 434; VM 416 may be interchangeable to, or a substantial clone of, VM 436; VM 418 may be interchangeable to, or a substantial clone of VM 438; VM 420 may be interchangeable to, or a substantial clone of, VM 440; VM 422 may be interchangeable to, or a substantial clone of, VM 442; and/or VM 424 may be interchangeable to, or a substantial clone of, VM 444. Accordingly, even a single one of VLS 1 and VLS 2 may perform the functionality of a complete logical site, for example, when another one of VLS 1 and VLS 2 is not operating in a production mode, e.g., when the other VLS is undergoing a changeover.

According to some demonstrative embodiments of the invention, topology 400 may also include a load balancer 408 to route traffic, e.g., production traffic and/or test traffic, to VMs of VLS 1 and VLS 2, e.g., as described above with reference to load balancer 280 (FIG. 2). Topology 400 may also include a virtualization manager 406 to manage VLSs 1 and 2, e.g., as described above with reference to manager 282 (FIG. 2). For example, load balancer 408 may route traffic to VMs of both VLS 1 and VLS 2, e.g., when both VLS 1 and VLS 2 are at the production mode of operation. Load balancer 408 may route, for example, all production traffic only to VMs of VLS 2, e.g., when VLS 1 is at a disconnected mode of operation. For example, when VLS 1 is at the disconnected mode of operation, e.g., during a change over of VLS 1, load balancer 408 may route all production traffic to VMs 430, 432, 434, 436, 438, 440, 442, and/or 444, for example, while not routing any production traffic to VMs 410, 412, 414, 416, 418, 420, 422, and/or 424. In this example, manager 406 may increase the amount of physical resources allocated to VMs 430, 432, 434, 436, 438, 440, 442, and/or 444, while decreasing the amount of physical resources allocated to VMs 410, 412, 414, 416, 418, 420, 422, and/or 424.

Reference is made to FIG. 5, which conceptually illustrates a VLS topology 500 including two VLSs, denoted “VLS X” and “VLS Y”, respectively, in accordance with some demonstrative embodiments of the invention. Although the invention is not limited in this respect, VLS topology 500 may perform the functionality of VLS topology 230 (FIG. 2). For example, VLS X and VLS Y may perform the functionality of VLSs 240 and 260 (FIG. 2), respectively.

According to some demonstrative embodiments of the invention, VLS X includes a HTTP service implemented by a first HTTP VM 530 running on a physical server 504, and a second HTTP VM 532 running on a physical server 506; a web application service and a database service commonly implemented by a first web+database VM 534 running on a physical server 508, and a second web+database VM 536 running on a physical server 510; a LDAP service implemented by a LDAP VM 538 running on a physical server 514; a DFS service implemented by a DFS VM 540 running on a physical server 516; a DNS service implemented by a DNS VM 542 running on a physical server 518; and a backup service implemented by a backup VM 544 running on a physical server 520. VLS Y includes a HTTP service implemented by a first HTTP VM 550 running on physical server 504, a second HTTP VM 552 running on physical server 506, and a third HTTP VM 556; a web application service implemented by a first web application VM 554 and a second web application VM 555 running on physical server 508, and a third web application VM 557 running on physical server 510; a DNS service implemented by a DNS VM 558 running on physical server 514; a DFS service implemented by a DFS VM 560 running on physical server 516; a LDAP service implemented by a LDAP VM 562 running on physical server 518; a backup service implemented by a backup VM 564 running on physical server 520; and a database service implemented by a database VM 565 running on a physical server 512.

According to the demonstrative embodiments of FIG. 5, each of servers 504, 506 and/or 520 commonly runs both a first VM of a service of VLS X and a corresponding VM of a service of VLS Y. As shown in FIG. 5, each of servers 504, 506 and/or 520 runs VMs of the same service type, e.g., servers 504 and 506 each run VMs of the HTTP services, and server 520 runs VMs of the backup services, respectively.

According to some demonstrative embodiments of the invention, one or more tiers of VLS X and VLS Y may be implemented using different VMs, which may be run by different physical servers. For example, servers 508, 510, 514, 516 and 518 each run VMs of different services of VLS X and Y.

According to some demonstrative embodiments of the invention, although VLS X and VLS Y may be implemented using different VMs, VLS X and VLS Y may be interchangeable, e.g., VLS X and VLS Y may perform substantially the same functionality. Accordingly, even a single one of VLS X and VLS Y may perform the functionality of a complete logical site, for example, when another one of VLS X and VLS Y is not operating in a production mode, e.g., when the other VLS is undergoing a changeover.

According to some demonstrative embodiments of the invention, topology 300 may also include a load manager/dispatcher 502 to route traffic, e.g., production traffic and/or test traffic, to VMs of VLS X and VLS Y, e.g., as described above with reference to load balancer 280 (FIG. 2). For example, load balancer 502 may route traffic to VMs of both VLS X and VLS Y, e.g., when both VLS X and VLS Y are at the production mode of operation. Load balancer 502 may route, for example, all production traffic only to VMs of VLS Y, e.g., when VLS X is at a disconnected mode of operation. For example, when VLS X is at the disconnected mode of operation, e.g., during a change over of VLS X, load balancer 502 may route all production traffic to VMs 550, 552, 554, 555, 556, 557, 558, 560, 562, 564, and/or 565, for example, while not routing any production traffic to VMs 530, 532, 534, 536, 538, 540, 542, and/or 544. In this example, the amount of physical resources allocated, e.g., by manager 282 (FIG. 2), to VMs 550, 552, 554, 555, 556, 557, 558, 560, 562, 564, and/or 565 may be increased while the amount of physical resources allocated to VMs 530, 532, 534, 536, 538, 540, 542, and/or 544 may be decreased.

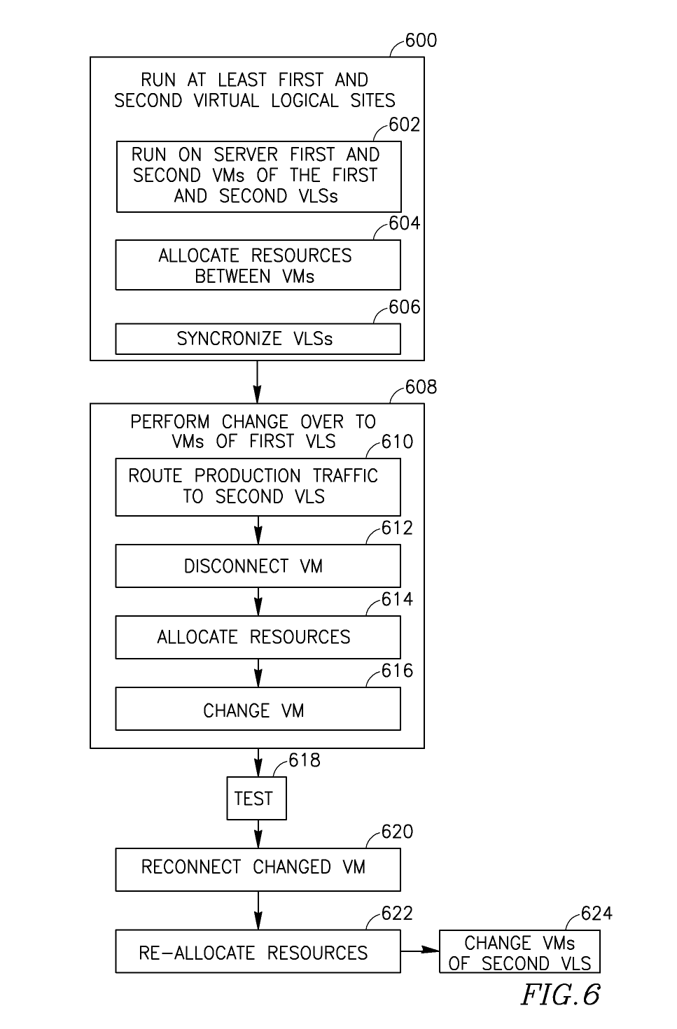

Reference is now made to FIG. 6, which schematically illustrates a method of operating a plurality of VLSs, in accordance with some demonstrative embodiments of the invention. Although the invention is not limited in this respect, one or more operations of the method of FIG. 6 may be performed by one or more components of computing system 200 (FIG. 2), for example, VLS topology 230 (FIG. 2), load balancer 280 (FIG. 2), and/or virtualization manager 282 (FIG. 2).

As indicated at block 600, the method may include running at least first and second VLSs. In one example, running the at least first and second VLSs comprises running on one or more servers at least first and second VLSs which are substantially interchangeable, e.g., as described above.

As indicated at block 602, in some demonstrative embodiments running the at least first and second VLSs may include running on a server at least one first virtual machine of a service of the first virtual logical site, and at least one second virtual machine of a service of the second virtual logical site. In some embodiments the first and second VMs may be interchangeable or substantial clones, as described above. In some embodiments the service of the first VLS and the service of the second VLS may be of the same service type, e.g., as described above. In other embodiments the service of the first VLS and the service of the second VLS may be of different service types, e.g., as described above.

As indicated at block 604, in some demonstrative embodiments the method may include allocating one or more physical resources of the server between the first and second VMs based on a traffic load of traffic intended for the first and second VLSs. For example, allocating the physical resources may be performed by a virtualization manager, e.g., as described above.

As indicated at block 606, in some demonstrative embodiments the method may include synchronizing between VMs of the first and second VLSs. For example, synchronizing between the first and second VLSs may be performed by a synchronization manager, e.g., as described above.

As indicated at block 608, in some demonstrative embodiments the method may also include performing a change over to one or more VMs of the first VLS.

As indicated at block 610, performing the change over may also include routing the production traffic to the second VLS. Accordingly, the production traffic may be handled, for example, by one or more VMs of the second VLS, e.g., including one or more VMs, which are substantial clones of the one or more VMs of the first VLS.

As indicated at block 612, performing the change over may include disconnecting the one or more VMs of the first VLS from production traffic.

As indicated at block 614, performing the change over may also include allocating one or more physical resources of one or more servers, running the one or more disconnected VMs, from the disconnected VMs to the one or more VMs of the second VLS.

As indicated at block 616, performing the change over may also include performing the change over to the one or more disconnected VMs resulting in one or more respective changed VMs.

As indicated at block 618, the method may also include testing the changed VMs, e.g., by connecting the changed VMs to a testing environment.

As indicated at block 620, the method may also include reconnecting the changed VMs to the production traffic, e.g., if testing of the changed VMs is successful. For example, the method may include routing at least part of the production traffic to the changed VMs.

As indicated at block 622, the method may also include re-allocating the physical resources of the servers to the changed VMs.

As indicated at block 624, the method may also include performing a changeover to one or more VMs of the second VLS. For example, substantially the same changeover applied to the VMs of the first VLS may be applied to the one or more VMs of the second VLS.

According to some demonstrative embodiments of the invention, implementing the VLS topologies described herein may enable implementing two or more logical sites with decreased hardware compared, for example, to the hardware required for implementing two or more physical logical sites, e.g., as described above with reference to FIG. 1. Additionally, the VLS topologies described herein may enable performing changeover and/or testing operations on the same VLS, which is used for handling production traffic. Accordingly, the VLS topology may enable receiving more accurate and/or efficient testing results. Additionally, the VLS topologies described herein may enable performing a change over without substantially disrupting the handling of the production traffic, e.g., since while one VLS is disconnected one or more other VLSs may handle the production traffic. Additionally, the VLS topologies described herein may enable performing multi-site synchronization in a relatively efficient and easy manner, e.g., since a common server may run services of two or more VLSs.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a RAM, a ROM, a rigid magnetic disk, and an optical disk. Some demonstrative examples of optical disks include CD-ROM, CD-R/W, and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A computing system comprising:
one or more servers to run at least first and second interchangeable virtual logical sites,
wherein a server of said one or more servers is to run at least one first virtual machine implementing at least part of said first virtual logical site and at least one second virtual machine implementing at least part of said second virtual logical site.

2. The computing system of claim 1, wherein said first and second virtual machines are interchangeable.

3. The computing system of claim 1, wherein said first virtual machine is a substantial clone of said second virtual machine.

4. The computing system of claim 1, wherein said first virtual machine implements a service of a type different than a service type implemented by said second virtual machine.

5. The computing system f claim 1, wherein said first and second virtual logical sites are substantial clones.

6. The computing system of claim 1 comprising at least one virtualization manager to allocate one or more physical resources of said server between said first and second virtual machines based on a traffic load of traffic intended for said first and second virtual logical sites.

7. The computing system of claim 1, comprising at least one synchronization manager to synchronize between corresponding virtual machines of said first and second virtual logical sites.

8. The computing system of claim 1, wherein when a change-over operation is to be performed said one or more servers are to:
route production traffic to said second virtual logical site;
modify said first virtual logical site to generate a modified first virtual logical site; and
route said production traffic to said modified first virtual logical site and to said second virtual logical site.

9. The computing system of claim 8, wherein said one or more servers are to operate said modified first virtual logical site in a testing environment.

10. The computing system of claim 8, wherein said server is to allocate one or more physical resources of said server between said first and second virtual machines during said change over operation.

11. The computing system of claim 8, wherein said one or more servers are to:
route said production traffic to said modified first virtual logical site;
modify said second virtual logical site to generate a modified second virtual logical site; and
route said production traffic to said modified first and second virtual logical sites.

12. The computing system of claim 1, wherein said at least one first virtual machine comprises a plurality of first virtual machines implementing a first plurality of services of said first virtual logical site, and
wherein said at least one second virtual machine comprises a plurality of second virtual machines implementing a second plurality of services of said second virtual logical site.

13. The computing system of claim 1 comprising a dispatcher to dispatch traffic to said first and second virtual logical sites via a single entry point.

14. A method comprising:
running on a server at least one first virtual machine implementing at least part of a first virtual logical site, and at least one second virtual machine implementing at least part of a second virtual logical site interchangeable with said first virtual logical site.

15. The method of claim 14, wherein said first and second virtual machines are interchangeable.

16. The method of claim 14, wherein said first virtual machine is a substantial clone of said second virtual machine.

17. The method of claim 14, wherein said first and second virtual logical sites are substantial clones.

18. The method of claim 14 comprising running said first and second virtual logical sites on a set of one or more servers including said server.

19. The method of claim 14 comprising allocating one or more physical resources of said server between said first and second virtual machines based on a traffic load of traffic intended for said first and second virtual logical sites.

20. The method of claim 14 comprising synchronizing between said first and second virtual logical sites.

21. The method of claim 14 comprising performing a change-over operation including:
routing production traffic to said second virtual logical site;
modifying said first virtual logical site to generate a modified first virtual logical site; and
routing said production traffic to said modified first virtual logical site and said second virtual logical site.

22. The method of claim 21 comprising allocating one or more physical resources of said server between said first and second virtual machines during said change over operation.

23. The method of claim 21 comprising:
routing said production traffic to said modified first virtual logical site;
modifying said second virtual logical site to generate a modified second virtual logical site; and
routing said production traffic back to said modified first and second virtual logical sites.

24. The method of claim 21 comprising operating said modified first virtual logical site in a testing environment.

25. The method of claim 14, wherein running said at least one first virtual machine comprises running on said server a plurality of first virtual machines implementing a first plurality of services of said first virtual logical site, and
wherein running said at least one second virtual machine comprises running on said server a plurality of second virtual machines implementing a second plurality of services of said second virtual logical site.

26. A server to run at least one first virtual machine implementing at least part of a first virtual logical site and at least one second virtual machine implementing at least part of a second virtual logical site interchangeable with said first virtual logical site.

27. The server of claim 26, wherein said first and second virtual machines are interchangeable.

28. The server of claim 26, wherein said first virtual machine is a substantial clone of said second virtual machine.

29. The server of claim 26, wherein said first and second virtual machines implement at least one different service.

30. The server of claim 26, wherein when a change-over operation is to be performed said server is to modify said first virtual machine.

31. The server of claim 30, wherein said server is to allocate one or more physical resources of said server between said first and second virtual machines during said change over operation.

32. The server of claim 26, wherein said at least one first virtual machine comprises a plurality of first virtual machines implementing a first plurality of services of said first virtual logical site, and
wherein said at least one second virtual machine comprises a plurality of second virtual machines implementing a second plurality of services of said second virtual logical site.

33. A computer program product comprising a computer-useable medium including a computer-readable program, wherein the computer-readable program when executed on at least one computer causes the computer to:
run at least one first virtual machine implementing at least part of a first virtual logical site, and at least one second virtual machine implementing at least part of a second virtual logical site interchangeable with said first virtual logical site.

34. The computer program product of claim 33, wherein said computer-readable program causes said at least one computer to allocate one or more physical resources of said computer between said first and second virtual machines based on a traffic load of traffic intended for said first and second virtual logical sites.

35. The computer program product of claim 33, wherein said computer-readable program causes said at least one computer to perform a change-over operation including:
routing production traffic to said second virtual logical site;
modifying said first virtual logical site to generate a modified first virtual logical site; and
routing said production traffic said modified first virtual logical site and said second virtual logical site.
